(19) United States
(12) Patent Application Publication
(10) Pub. No.: US 2009/0083024 A1
(43) Pub. Date: Mar. 26, 2009

(54) APPARATUS, METHOD, COMPUTER PROGRAM PRODUCT, AND SYSTEM FOR MACHINE TRANSLATION

(76) Inventors: Hirokazu Suzuki, Tokyo (JP); Satoshi Kinoshita, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/050,464

(22) Filed: Mar. 18, 2008

(30) Foreign Application Priority Data
Sep. 20, 2007 (JP) 2007-243195

(51) Int. Cl. G06F 17/28

(52) U.S. Cl. 704/4

(57) ABSTRACT

A receiving unit receives a translation request including an input sentence and bilingual term information. An original-sentence obtaining unit calculates a similarity between the input sentence and original sentences, and obtains an original sentence having the similarity higher than a threshold value from an original-sentence storage unit. A bilingual-term-information obtaining unit obtains bilingual term information having a bilingual term information ID corresponding to the obtained original sentence, from a dictionary storage unit. A translating unit translates a first word included in the input sentence into a corresponding second word in the obtained bilingual term information, when the first word in the obtained bilingual term information is included in the input sentence. A storage unit stores the bilingual term information included in the translation request in the dictionary storage unit, and stores the bilingual term information ID of the stored bilingual term information and the input sentence, related to each other, in the original-sentence storage unit.

### CROSS-REFERENCE TO RELATED APPLICATIONS

This application is based upon and claims the benefit of priority from the prior Japanese Patent Application No. 2007-243195, filed on Sep. 20, 2007; the entire contents of which are incorporated herein by reference.

### BACKGROUND OF THE INVENTION

1. Field of the Invention

The present invention relates to an apparatus, a method, a computer program product, and a system that receives a translation request from a client terminal, performs a translation process from a first language that is a language of an input sentence into a second language that is a language of an output sentence on a server end, and transmits a translation result to the client terminal as a request source.

2. Description of the Related Art

Machine translation systems including plural client terminals utilized by users that request translation, and a machine translation server that provides a machine translation function are known. These machine translation systems perform translation by using bilingual term information that is combinations of words in an original language designated by the users during translation and translations of the words, or document field information. Such a machine translation system can provide high-quality machine translation by using translations that are indicated by the user in the bilingual term information, or using a translation dictionary that is determined according to the designated document field information.

For example, JP-A 2003-223442 (KOKAI) proposes a technique of learning bilingual term information designated by the user for each field, and utilizing the learned bilingual term information during the translation. JP-A 2003-296327 (KOKAI) proposes a technique of utilizing field information provided by the user to determine a dictionary to be used.

The technique as described in JP-A 2003-223442 or 2003-296327 (KOKAI) is effective when a document to be translated rests on one field. When one document includes sentences associated with plural fields like news articles, the translation quality can be deteriorated.

In these techniques, a field must be expressly given during translation. The translation qualities vary depending on the granularity of the field. For example, when a field of “sports” is set, translations of a word may vary depending on the type of sports such as “baseball” and “soccer”. In such cases, ambiguities are left in selection of the translations.

When a finely-divided field is set depending on the type of sports like “baseball” or “soccer”, few ambiguities are left. However, when there are translations that are commonly used in plural sports, the commonly-used translations cannot be referred to because of fineness of the designated field, which can deteriorate the translation quality.

### SUMMARY OF THE INVENTION

According to one aspect of the present invention, a machine translation apparatus includes a dictionary storage unit configured to store bilingual term information in which first words in a first language and second words in a second language are related to each other, and identification information that identifies the bilingual term information; an original-sentence storage unit configured to store original sentence in the first language and the identification information of the bilingual term information used for translating the original sentence, which are related to each other; a receiving unit configured to receive a translation request including an input sentence in the first language; an original-sentence obtaining unit configured to calculate a similarity between the input sentence and the original sentence, and to obtain the original sentence having the similarity higher than a predetermined threshold value, from the original-sentence storage unit; a bilingual-term-information obtaining unit configured to obtain the bilingual term information having the identification information corresponding to the original sentence obtained by the original-sentence obtaining unit, from the dictionary storage unit; and a translating unit configured to determine whether the first word in the bilingual term information obtained by the bilingual-term-information obtaining unit is included in the input sentence, and to translate the first word included in the input sentence into the second word in the bilingual term information, when the first word is included in the input sentence.

According to another aspect of the present invention, a machine translation method includes receiving a translation request including an input sentence in a first language;

calculating a similarity between the input sentence and original sentence in the first language; obtaining the original sentence having the similarity higher than a predetermined threshold value, from an original-sentence storage unit configured to store the original sentence and identification information of bilingual term information used for translating the original sentence and relating first words in the first language and second words in a second language to each other; obtaining the bilingual term information having the identification information corresponding to the obtained original sentence, from a dictionary storage unit configured to store the bilingual term information and the identification information; determining whether the first word in the obtained bilingual term information is included in the input sentence; and translating the first word included in the input sentence into the second word in the bilingual term information, when the first word is included in the input sentence.

According to still another aspect of the present invention, a machine translation system includes a terminal apparatus configured to request a translation; and a machine translation apparatus configured to be connected to the terminal apparatus via a network.

The terminal apparatus includes a request transmitting unit configured to transmit a translation request including an input sentence in a first language; and a result receiving unit configured to receive a translation result.

The machine translation apparatus includes a dictionary storage unit configured to store bilingual term information in which first words in the first language and second words in a second language are related to each other, and identification information that identifies the bilingual term information; an original-sentence storage unit configured to store original sentence in the first language and the identification information of the bilingual term information used for translating the original sentence, which are related to each other; a receiving unit configured to receive the translation request including the input sentence in the first language; an original-sentence obtaining unit configured to calculate a similarity between the input sentence and the original sentence, and obtain the original sentence having the similarity higher than a predetermined threshold value, from the original-sentence storage unit; a bilingual-term-information obtaining unit configured to obtain the bilingual term information having the identification information corresponding to the original sentence obtained by the original-sentence obtaining unit, from the dictionary storage unit; a translating unit configured to determine whether the first word in the bilingual term information obtained by the bilingual-term-information obtaining unit is included in the input sentence, and translate the first word included in the input sentence into the second word in the bilingual term information, when the first word is included in the input sentence; and an output unit configured to output the translation result translated by the translating unit to the terminal apparatus.

A computer program product according to still another aspect of the present invention causes a computer to perform the method according to the present invention.

### BRIEF DESCRIPTION OF THE DRAWINGS

FIG. 1 is a block diagram of a configuration of a machine translation system according to a first embodiment of the present invention;

FIG. 2 is a diagram illustrating an example of a structure of data stored in an original-sentence storage unit according to the first embodiment;

FIG. 3 is a diagram illustrating an example of a structure of data stored in a dictionary storage unit according to the first embodiment;

FIG. 4 is a flowchart of an overall flow of a machine translation process according to the first embodiment;

FIG. 5 is a diagram illustrating an example of another structure of data stored in the original-sentence storage unit according to the first embodiment;

FIG. 6 is a diagram illustrating an example of another structure of data stored in the dictionary storage unit according to the first embodiment;

FIG. 7 is a block diagram of a configuration of a machine translation system according to a second embodiment of the present invention;

FIG. 8 is a diagram illustrating an example of a structure of data stored in an original-sentence storage unit according to the second embodiment;

FIG. 9 is a flowchart of an overall flow of a machine translation process according to the second embodiment;

FIG. 10 is a diagram illustrating an example of a structure of data stored in a dictionary storage unit according to the second embodiment; and

FIG. 11 is a schematic diagram illustrating a hardware configuration of a machine translation apparatus according to the first and second embodiments.

### DETAILED DESCRIPTION OF THE INVENTION

Exemplary embodiments of an apparatus, a method, a computer program product, and a system according to the present invention are explained in detail with reference to the accompanying drawings.

A machine translation system according to a first embodiment of the present invention receives a translation request from a client as a terminal device, performs a translation process from a first language that is a language of an input sentence into a second language that is a language of an output sentence in a machine translation server as a machine translation apparatus, and transmits a result of the translation to the request source. At this time, the user can designate sets of words in the first language and words in the second language, which are translations of the words, as bilingual term information. The machine translation server uses the designated bilingual term information during the translation, to obtain translations.

The machine translation system according to the first embodiment stores the bilingual term information designated by plural users and input sentences, being related to each other. When a sentence similar to an input sentence that is requested to translate is stored, the machine translation system also refers to the bilingual term information that is related to the stored sentence, to translate the input sentence with high accuracy.

Machine translation between English and Japanese is explained below as an example. The languages used at the translation are not limited thereto. The present invention can be applied to machine translation between any languages.

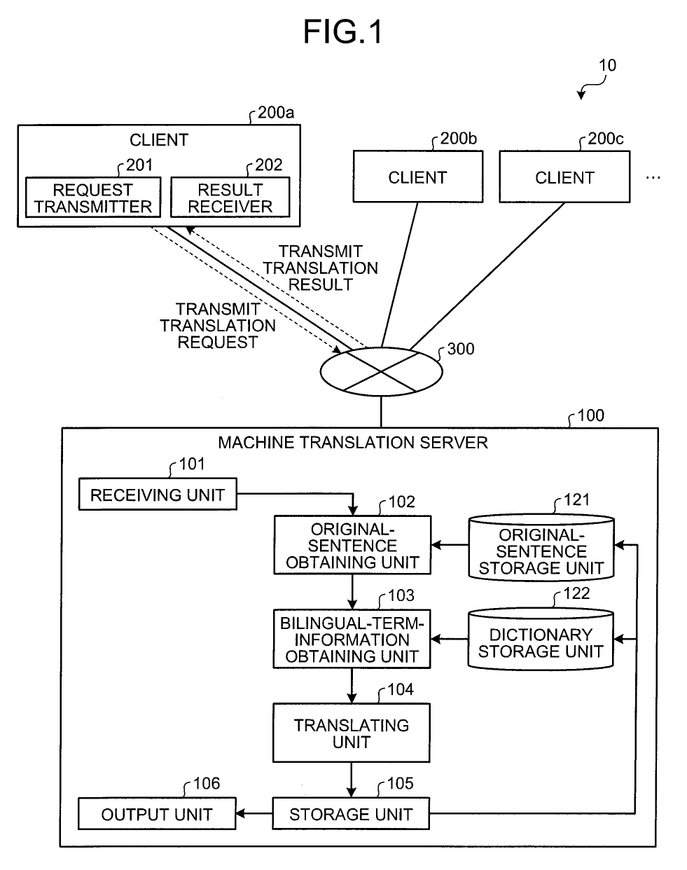

As shown in FIG. 1, a machine translation system 10 has a configuration in which a machine translation server 100 and plural clients 200a to 200c are connected through a network 300 such as the Internet and a local area network (LAN).

The clients 200a to 200c transmit a translation request including an input sentence to be translated and bilingual term information that is used during translation of the input sentence to the machine translation server 100, and receive a translation result from the machine translation server 100, thereby translating a desired input sentence. The clients 200a to 200c have the same configuration, and thus are also referred to simply as clients 200. The number of the clients 200 is not limited to three.

The machine translation server 100 performs machine translation in response to the translation request from the clients 200a to 200c, and returns a translation result to one of the clients 200a to 200c that requests the translation. Details of a function of the machine translation server 100 are explained later.

Details of a function of the client 200 are explained below. As shown in FIG. 1, the client 200 includes a request transmitter 201 and a result receiver 202.

The request transmitter 201 transmits the translation request to the machine translation server 100. As described above, the translation request includes the input sentence to be translated, and the bilingual term information to be used during translation. The translation request further includes identification information that can identify a user, such as a name of the user requesting the translation. The identification information is used for identifying a user that transmits the translation request. The user can request translation without designating the bilingual term information. In this case, information other than the bilingual term information is set in the translation request.

The result receiver 202 receives the translation result that is obtained by the machine translation server 100 that translates the input sentence in response to the translation request.

The client 200 can perform the transmission of the translation request and the reception of the translation result according to an application (not shown) having a function of designating the input sentence to be translated or the bilingual term information to be used, and a function of displaying the translation result.

Details of a function of the machine translation server 100 are explained. As shown in FIG. 1, the machine translation server 100 includes an original-sentence storage unit 121, a dictionary storage unit 122, a receiving unit 101, an original-sentence obtaining unit 102, a bilingual-term-information obtaining unit 103, a translating unit 104, a storage unit 105, and an output unit 106.

The original-sentence storage unit 121 stores input sentences to which translation requests were previously issued, so that bilingual term information that was used at the previous translation of the input sentences can be referred to. The previous input sentences that are stored in the original-sentence storage unit 121 are also referred to as original sentence information.

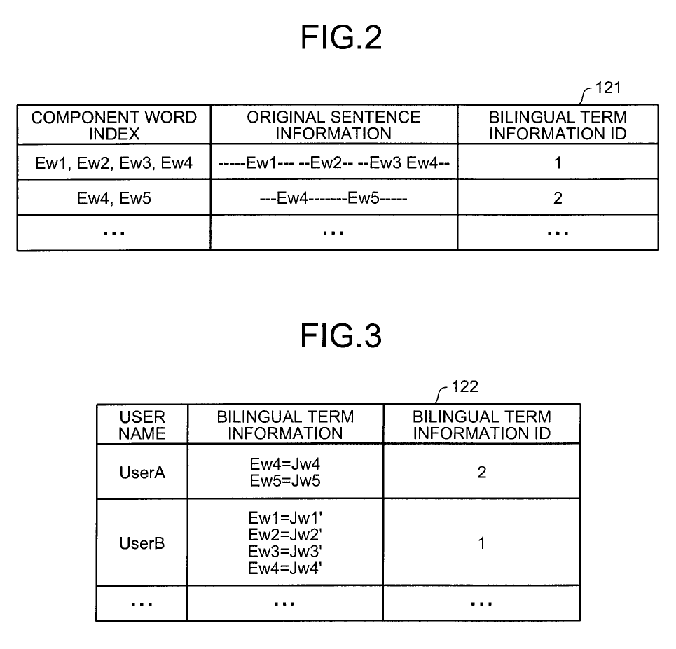

As shown in FIG. 2, the original-sentence storage unit 121 stores data of a component word index, original sentence information, and a bilingual term information ID, which are related to each other. The component word index is used to effectively retrieve the original sentence information.

According to the first embodiment, a component word index listing words that are obtained by performing a morphological analysis of the original sentence information is employed. When original sentence information that is similar to the input sentence is to be retrieved, only original sentence information that is restricted by using the component word index is targeted, which eliminates the need to target all the original sentence information, and increases efficiency of the retrieval process.

The bilingual term information ID is identification information used for identifying the bilingual term information designated when the original sentence information was requested to translate.

Returning to FIG. 1, the dictionary storage unit 122 stores bilingual term information that are sets of words in a first language and translations of the words in a second language, which is designated at the same time as the designation of the input sentence that is requested to translate.

As shown in FIG. 3, the dictionary storage unit 122 stores data of a user name, bilingual term information, and a bilingual term information ID, which are related to each other. The user name is a name of a user that requests translation. The bilingual term information is set in the form of “a word in the first language=translation in the second language”. When plural sets of words in the first language and translations in the second language are designated, the plural sets are set in the bilingual term information. In FIG. 3, two sets of “Ew4=Jw4” and “Ew5=Jw5” are designated as the bilingual term information for the user name=UserA.

The bilingual term information ID is used for identifying the bilingual term information as described above. The bilingual term information ID is used for relating the original sentence information that is stored in the original-sentence storage unit 121 to the bilingual term information that is stored in the dictionary storage unit 122. That is, when the dictionary storage unit 122 is searched by using the bilingual term information ID corresponding to certain original sentence information in the original-sentence storage unit 121, bilingual term information that was designated when the translation request for the original sentence information was issued can be obtained.

The original-sentence storage unit 121 and the dictionary storage unit 122 can be configured by any storage medium that is commonly utilized, such as a hard disk drive (HDD), an optical disk, a memory card, and a random access memory (RAM).

The storage methods for the original sentence information and the bilingual term information are not limited to those above mentioned. Any storage method can be adopted so long as the bilingual term information that was designated at the request of translation of any original sentence can be identified.

Returning to FIG. 1, the receiving unit 101 receives the translation request transmitted from the client 200.

The original-sentence obtaining unit 102 calculates a similarity between the input sentence and the original sentence information stored in the original-sentence storage unit 121, to obtain original sentence information having the similarity that is higher than a predetermined threshold value. Specifically, the original-sentence obtaining unit 102 performs a morphological analysis to divide the input sentence into words. The original-sentence obtaining unit 102 obtains original sentence information that includes each of the divided words in the component word index, from the original-sentence storage unit 121.

The original-sentence obtaining unit 102 calculates a similarity between each of the obtained original sentence information and the input sentence. The original-sentence obtaining unit 102 calculates the similarity based on an edit distance between the original sentence information and the input sentence. That is, the original-sentence obtaining unit 102 assigns a higher similarity to original sentence information having a smaller edit distance from the input sentence than original sentence information having a larger edit distance from the input sentence. The similarity calculation method is not limited thereto. Any method can be adopted that can calculate a degree of similarity between sentences.

The bilingual-term-information obtaining unit 103 obtains bilingual term information from the dictionary storage unit 122, by using a bilingual term information ID corresponding to the original sentence information obtained by the original-sentence obtaining unit 102 as a search key.

The original-sentence obtaining unit 102 and the bilingual-term-information obtaining unit 103 enable to obtain the original sentence information similar to the input sentence and the bilingual term information that was used during translation of the original sentence.

The translating unit 104 translates the input sentence that is requested to translate. A translation method by the translating unit 104 can be a transfer method that is configured at a step of processing such as analysis, transfer, and generation, or an intermediate language method. That is, any translation method commonly used can be applied so long as the method performs translation using translations designated by the bilingual term information.

The translating unit 104 translates the input sentence by referring to various kinds of translation dictionaries such as a user customized dictionary, a terminology dictionary, and a translation rule dictionary (not shown). The translating unit 104 has a function of registering/deleting/revising other information such as a source word, a translation, and a condition designated by the user into/from/in the user customized dictionary.

The translating unit 104 translates the input sentence by using the bilingual term information designated by the user in the translation request. That is, the translating unit 104 translates the input sentence by using a translation designated in the bilingual term information in priority to a translation obtained from the translation dictionary. The translating unit 104 determines whether the bilingual term information is obtained by the bilingual-term-information obtaining unit 103. When the bilingual term information is obtained, the translating unit 104 translates the input sentence by using the obtained bilingual term information in addition to the bilingual term information designated by the user in the translation request. When no bilingual term information is designated in the translation request, the translating unit 104 translates the input sentence by using only the bilingual term information obtained by the bilingual-term-information obtaining unit 103. When no bilingual term information is designated in the translation request and when no bilingual term information is obtained by the bilingual-term-information obtaining unit 103, the translating unit 104 translates the input sentence by referring to only the translation dictionary as mentioned above, without using the bilingual term information.

The storage unit 105 assigns a new bilingual term information ID to the bilingual term information included in the translation request, to be stored in the dictionary storage unit 122. The storage unit 105 relates the stored bilingual term information ID of the bilingual term information and the input sentence that is requested to translate, to be stored in the original-sentence storage unit 121.

The output unit 106 outputs a translation result of the input sentence by the translating unit 104 to the client 200.

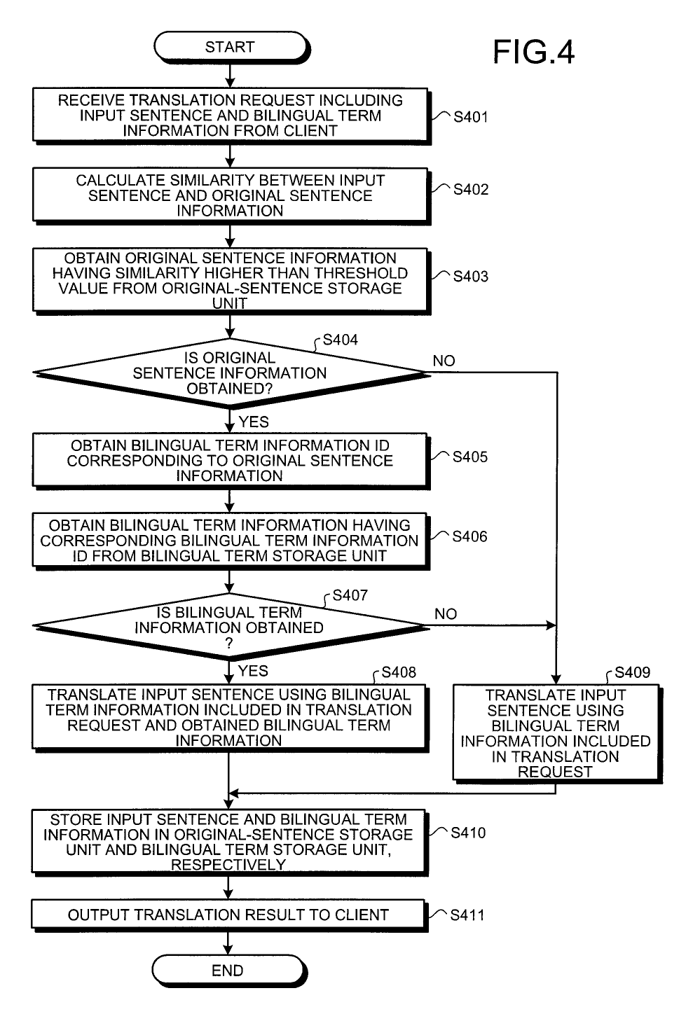

A machine translation process performed by the machine translation server 100 according to the first embodiment is explained with reference to FIG. 4.

The receiving unit 101 receives a translation request including the input sentence and the bilingual term information from the client 200 (step S401). The original-sentence obtaining unit 102 calculates a similarity between the input sentence and the original sentence information stored in the original-sentence storage unit 121 (step S402).

Specifically, the original-sentence obtaining unit 102 obtains from the original-sentence storage unit 121, original sentence information that has a component word index including each of words that are obtained by a morphological analysis of the input sentence. The original-sentence obtaining unit 102 calculates a similarity between each of the original sentence information and the input sentence so that the similarity is higher when the edit distance between the obtained original sentence information and the input sentence is smaller.

The original-sentence obtaining unit 102 compares the similarity and a predetermined threshold value, and obtains original sentence information having the similarity higher than the threshold value (step S403). The original-sentence obtaining unit 102 can be adapted to obtain a predetermined number of pieces of original sentence information having higher similarities, among the original sentence information having higher similarities than the threshold value. The original-sentence obtaining unit 102 can be adapted to obtain only original sentence information having the similarity higher than the threshold value and having the highest similarity.

The bilingual-term-information obtaining unit 103 determines whether the original sentence information is obtained (step S404). When the original sentence information is obtained (YES at step S404), the bilingual-term-information obtaining unit 103 obtains a bilingual term information ID corresponding to the original sentence information from the original-sentence storage unit 121 (step S405). The bilingual-term-information obtaining unit 103 obtains bilingual term information having the corresponding bilingual term information ID from the dictionary storage unit 122 (step S406).

The translating unit 104 determines whether the bilingual term information is obtained by the bilingual-term-information obtaining unit 103 (step S407). When the bilingual term information is obtained (YES at step S407), the translating unit 104 translates the input sentence by using the obtained bilingual term information in addition to the bilingual term information designated by the user in the translation request (step S408).

According to this process, for a word to which no bilingual term information is designated by the user, a more appropriate translation result can be obtained by using bilingual term information that was used when a similar sentence was previously translated.

When no bilingual term information is obtained (NO at step S407), the translating unit 104 translates the input sentence by using the bilingual term information designated by the user in the translation request (step S409).

The storage unit 105 stores the input sentence and the bilingual term information in the original-sentence storage unit 121 and the dictionary storage unit 122, respectively (step S410). Specifically, the storage unit 105 assigns a new bilingual term information ID to the bilingual term information included in the translation request, to be stored in the dictionary storage unit 122. The storage unit 105 generates a component word index from the words obtained by the original-sentence obtaining unit 102 at step S402, and stores data of the generated component word index, the input sentence, and the assigned bilingual term information ID, which are related to each other, in the original-sentence storage unit 121.

The output unit 106 outputs a translation result of the input sentence by the translating unit 104 to the client 200 that transmits the translation request (step S411), and terminates the machine translation process.

These steps do not always have to be performed in the order above mentioned. For example, among the processes performed by the translating unit 104, processes other than the process of selecting a translation of a word by using the bilingual term information can be performed in parallel to the process of obtaining the relevant bilingual term information (steps S402 to S407). The order of the process of storing the information in the corresponding storage units (step S410) and the process of outputting the translation result to the client 200 (step S411) can be switched, or these processes can be performed in parallel.

A specific example of the machine translation process according to the first embodiment is explained. Explanations are given of a case that a user having a user name of UserA (hereinafter, simply UserA) requests translation through the client 200. The UserA transmits a translation request including an input sentence to be translated and bilingual term information to be adopted during translation of the input sentence, to the machine translation server 100.

It is assumed here that the UserA designates an input sentence “----- Ew1 --- -- Ew2 -- -- Ew3 ----” including three words of Ew1, Ew2, and Ew3, and bilingual term information of “Ew2=Jw2” to determine a Japanese translation of the English word Ew2 as Jw2.

Parts represented by a sign “-” indicate those that are not important in similarity determination. Some methods for similarity determination to be adopted use all character sequences in the input sentence, and some use only part of words included therein. Character sequences to be used depend on the similarity determination methods to be adopted. Therefore, what are the parts represented by the sign “-” is not important.

The machine translation server 100 receives the translation request including the input sentence and the bilingual term information from the client 200 (step S401). While a machine translation process that is usually performed for the input sentence is performed, the original-sentence obtaining unit 102 retrieves original sentence information having a highest similarity to the input sentence, among original sentence information stored in the original-sentence storage unit 121 (step S403). In this case, original sentence information “----- Ew1 --- -- Ew2 -- -- Ew3 Ew4 -- ” including four words of Ew1, Ew2, Ew3, and Ew4 is retrieved as an original sentence having a highest similarity, from the original-sentence storage unit 121 that stores the data as shown in FIG. 2.

The bilingual-term-information obtaining unit 103 obtains a bilingual term information ID related to the original sentence information (step S405). In the case as shown in FIG. 2, the bilingual-term-information obtaining unit 103 obtains 1 as the bilingual term information ID.

The bilingual-term-information obtaining unit 103 retrieves bilingual term information having the bilingual term information ID=1 from the dictionary storage unit 122 as shown in FIG. 3 (step S406). Four pieces of registered bilingual term information of “Ew1=Jw1′”, “Ew2=Jw2′”, “Ew3=Jw3′”, and “Ew4=Jw4′” are obtained in this process.

The input sentence includes only the words Ew1, Ew2, and Ew3, and the UserA designates only the bilingual term information associated with Ew2. Therefore, with regard to the remaining words Ew1 and Ew3, the translating unit 104 uses the bilingual term information of “Ew1=Jw1′” and “Ew3=Jw3′” obtained in the above process, to translate the input sentence (step S408).

If the UserA designates no bilingual term information, the translating unit 104 translates the input sentence by using the three pieces of bilingual term information of “Ew1=Jw1′”, “Ew2=Jw2′”, and “Ew3=Jw3′”.

When plural pieces of original sentence information are obtained, the corresponding bilingual term information can be merged. Alternately, bilingual term information corresponding to original sentence information having a higher similarity can be used.

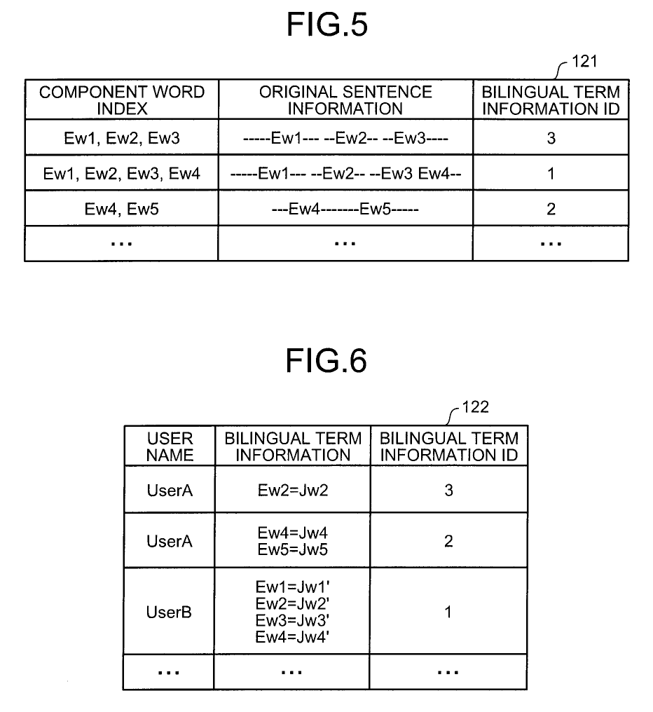

After the translation, the storage unit 105 stores information of the input sentence in the original-sentence storage unit 121, and stores the bilingual term information designated by the user in the dictionary storage unit 122 (step S410). FIG. 5 depicts a state of the original-sentence storage unit 121 of FIG. 2 after the information of the input sentence is registered therein. As shown in FIG. 5, the input sentence including three words (Ew1, Ew2, and Ew3) is added as new original sentence information.

FIG. 6 depicts a state of the dictionary storage unit 122 of FIG. 3 after the bilingual term information designated at this translation is registered therein. As shown in FIG. 6, the bilingual term information having the bilingual term information ID=3 is newly added.

When another translation is requested thereafter, the translation process, the process of storing the original sentence information, and the process of storing the bilingual term information are repeated by using updated original sentence information and bilingual term information. That is, each time the client 200 requests translation, the information of the original-sentence storage unit 121 and the dictionary storage unit 122 is upgraded, and translation knowledge is accumulated.

In the machine translation system 10 that can be utilized by many users like in the first embodiment, a sentence that is requested to translate by a user, or a sentence similar thereto may have already been translated according to a translation request from another user.

In such cases, because the machine translation apparatus according to the first embodiment can accumulate previous translation knowledge, it can refer to the translation knowledge to obtain a high-quality translation. Specifically, a word to which no translation is indicated can be translated by using bilingual term information that was referred to during translation of a sentence similar to the input sentence. Thus, a higher-quality translation can be obtained as compared to a case that a dictionary source word is simply retrieved to output a translation.

Even when one document includes sentences in plural fields, because the similarity determination is performed in units of sentences, an appropriate translation for each sentence can be selected. Thus, the translation quality is not deteriorated even when one document includes sentences associated with plural fields. Each time the user requests translation of an original sentence having bilingual term information attached thereto, the bilingual term information is consecutively upgraded. Therefore, when a larger number of users request translations, higher-quality translation is realized.

A machine translation apparatus according to a second embodiment of the present invention converts an input sentence into a form capable of comparing similarities to other sentences, and compares the similarities to other sentences that were previously translated and similarly converted, to obtain relevant bilingual term information.

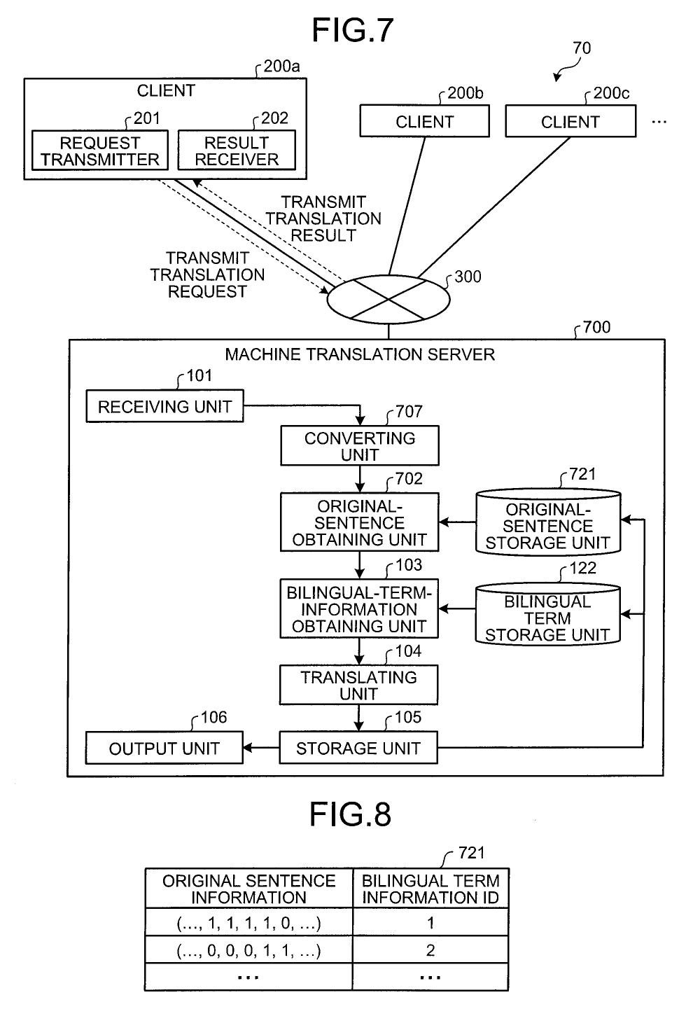

As shown in FIG. 7, a machine translation system 70 includes a machine translation server 700, and the plural clients 200a to 200c, which are connected through the network 300.

According to the second embodiment, a configuration of the machine translation server 700 is different from that in the first embodiment. Other components and functions are the same as those shown in FIG. 1, which is a block diagram of the configuration of the machine translation system 10 according to the first embodiment. Therefore, these components are denoted by like reference numerals, and explanations thereof will be omitted.

The machine translation server 700 includes an original-sentence storage unit 721, the dictionary storage unit 122, the receiving unit 101, an original-sentence obtaining unit 702, the bilingual-term-information obtaining unit 103, the translating unit 104, the storage unit 105, the output unit 106, and a converting unit 707.

The second embodiment is different from the first embodiment in a structure of data stored in the original-sentence storage unit 721, a function of the original-sentence obtaining unit 702, and addition of the converting unit 707. Other components and functions are the same as those shown in FIG. 1, which is the block diagram of the machine translation system 10 according to the first embodiment. Therefore, these components are denoted by like reference numerals, and explanations thereof will be omitted.

The original-sentence storage unit 721 is different from the original-sentence storage unit 121 according to the first embodiment in that the original-sentence storage unit 721 stores original sentence information converted into a form capable of comparing similarities to other sentences. The form capable of comparing the similarities is defined according to the similarity calculation methods. In the second embodiment, the input sentence is converted into a vector form by converting frequencies of words included in the input sentence into vectors, and a cosine similarity is employed as the similarity.

The similarity calculation method and the conversion method are not limited thereto. Any similarity calculation method and conversion method can be adopted so long as the input sentence is converted to compare similarities to other sentences. For example, the similarity can be calculated after the divided words are normalized. The normalization indicates standardization of words that have the same meaning but are different in notation, such as “ [symbol] [symbol] ” and “ [symbol] ” into a typical notation. A method of referring to a syntactical structure of a sentence to calculate a syntactic similarity, or a method of considering a similarity in a dependency structure of a linguistic expression to obtain a similarity of the linguistic expression can be applied.

As shown in FIG. 8, the original-sentence storage unit 721 stores data of original sentence information expressed in vector forms and bilingual term information IDs, which are related to each other. For explanations, FIG. 8 depicts examples of vectors that represent frequencies of appearance of the words Ew1, Ew2, Ew3, Ew4, and Ew5 from the left, respectively. A sign “. . . ” indicates that other words are omitted.

FIG. 8 depicts a case that the original sentence information of FIG. 2 depicting the original-sentence storage unit 121 according to the first embodiment is converted into vector forms. That is, because the original sentence information in the first row of FIG. 2 includes the words Ew1, Ew2, Ew3, and Ew4, the corresponding vectors in FIG. 8 are ( . . . , 1, 1, 1, 1, 0, . . . ). Because the original sentence information in the second row of FIG. 2 includes the word Ew4 and Ew5, the corresponding vectors in FIG. 8 are ( . . . , 0, 0, 0, 1, 1, . . . ).

The converting unit 707 converts the input sentence in to a predetermined form capable of comparing similarities to other sentences. Specifically, the converting unit 707 performs a morphological analysis of the input sentence to divide into words. The converting unit 707 converts the frequency of each of the divided words into a vector, to convert the input sentence into a vector form.

The original-sentence obtaining unit 702 calculates a cosine similarity between the input sentence in the form that has been converted by the converting unit 707 and the original sentence information stored in the original-sentence storage unit 721, and obtains original sentence information having the cosine similarity higher than a predetermined threshold value.

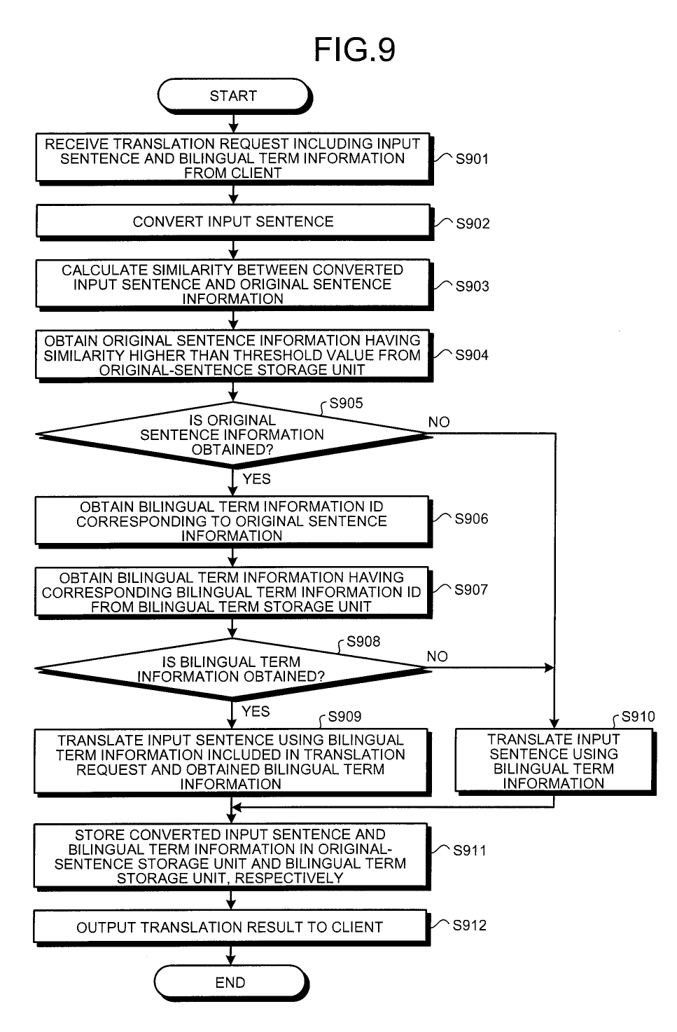

A machine translation process performed by the machine translation server 700 according to the second embodiment is explained with reference to FIG. 9.

A translation request receiving process at step S901 is the same as that at step S401 in the machine translation server 100 according to the first embodiment, and thus explanations thereof will be omitted.

The converting unit 707 converts the input sentence into a form capable of comparing the similarity, i.e., a vector form (step S902). The original-sentence obtaining unit 702 calculates a cosine similarity between the input sentence and the original sentence information stored in the original-sentence storage unit 721 (step S903).

The original-sentence obtaining unit 702 compares the calculated cosine similarity and the predetermined threshold value, and obtains original sentence information having the cosine similarity higher than the threshold value (step S904).

A bilingual term information obtaining process and a translating process from steps S905 to S910 are the same processes from steps S404 to S409 in the machine translation server 100 according to the first embodiment, and thus explanations thereof will be omitted.

After the translating unit 104 translates the input sentence, the storage unit 105 stores the converted input sentence and the bilingual term information in the original-sentence storage unit 721 and the dictionary storage unit 122, respectively (step S911).

A translation result output process at step S912 is the same process at step S411 in the machine translation server 100 according to the first embodiment, and thus explanations thereof will be omitted.

The machine translation apparatus according to the second embodiment converts the input sentence in a form capable of comparing similarities to other sentences, and compares the similarities to sentences that were previously translated and similarly converted, to obtain the relevant bilingual term information.

In the above embodiments, when plural pieces of original sentence information are obtained, all of bilingual term information is utilized, or bilingual term information corresponding to original sentence information having a higher similarity is utilized. Relevant information can be related to the original sentence information or the bilingual term information, to obtain a priority of the bilingual term information based on the relevant information and utilize bilingual term information having a higher priority.

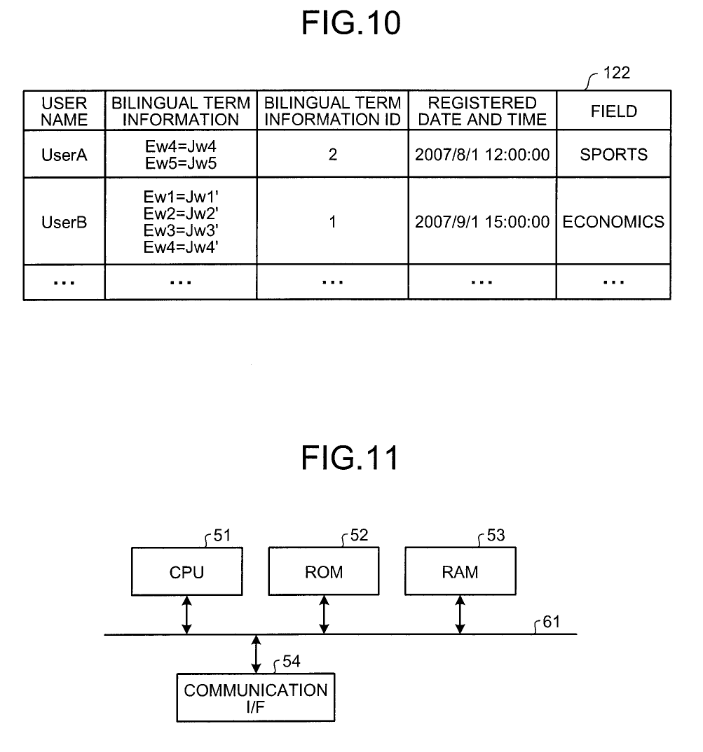

As shown in FIG. 10, according to this modified example, in addition to the user name, the bilingual term information, and the bilingual term information ID, the dictionary storage unit 122 stores data of a date and time when the bilingual term information is registered in the dictionary storage unit 122, and a field to which the bilingual term information is applied, which are related as relevant information.

The bilingual-term-information obtaining unit 103 is adapted to, when obtaining plural pieces of bilingual term information, preferentially obtain bilingual term information having a more recent registration date and time, for example. By including designation of a filed in the translation request, the bilingual-term-information obtaining unit 103 can be adapted to preferentially obtain bilingual term information that is related to the designated field.

The priority of the bilingual term information can be determined according to authorities of the users. For example, an authority of a user corresponding to a user name is obtained by utilizing a user management database (not shown) or the like. When the user has an administrator authority, the user can select bilingual term information in priority to users having other authorities. By determining the user name in the dictionary storage unit 122, bilingual term information that was used when the user himself/herself previously requested translation can be utilized in preference to bilingual term information of other users. When users are managed in units of groups including plural users, bilingual term information that was used when the group to which the user belongs previously requested translation can be utilized in preference to bilingual term information of users in other groups. In this case, instead of the user name in the dictionary storage unit 122, or together with the user name, a group name for identifying a group is registered.

A hardware configuration of a machine translation apparatus according to the first and second embodiments is explained with reference to FIG. 11.

The machine translation apparatus according to the first or second embodiment includes a controller such as a central processing unit (CPU) 51, storage devices such as a read only memory (ROM) 52 and a RAM 53, a communication interface (I/F) 54 that connects to a network to establish communications, an external storage device such as a HDD and a compact disc (CD) drive, a display device such as a display unit, an input device such as a keyboard and a mouse, and a bus 61 that connects these components. The machine translation apparatus has a hardware configuration utilizing a common computer.

A machine translation program executed by the machine translation apparatus according to the first or second embodiment is provided being recorded in a file of an installable or executable format on a computer-readable storage medium such as a compact disk read only memory (CD-ROM), a flexible disk (FD), a compact disk recordable (CD-R), and a digital versatile disk (DVD).

The machine translation program executed by the machine translation apparatus according to the first or second embodiment can be stored in a computer that is connected to a network such as the Internet, and downloaded through the network. The machine translation program executed by the machine translation apparatus according to the first or second embodiment can be provided or distributed through a network such as the Internet.

The machine translation program according to the first or second embodiment can be previously installed in the ROM or the like.

The machine translation program executed by the machine translation apparatus according to the first or second embodiment has a module configuration including the components as mentioned above (the receiving unit, the original-sentence obtaining unit, the bilingual-term-information obtaining unit, the translating unit, the storage unit, and the output unit). As actual hardware, the CPU 51 (processor) reads and executes the machine translation program from the storage medium, so that the components above mentioned are loaded in a main memory and generated on the main memory.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A machine translation apparatus comprising:
a dictionary storage unit configured to store bilingual term information in which first words in a first language and second words in a second language are related to each other, and identification information that identifies the bilingual term information;
an original-sentence storage unit configured to store original sentence in the first language and the identification information of the bilingual term information used for translating the original sentence, which are related to each other;
a receiving unit configured to receive a translation request including an input sentence in the first language;
an original-sentence obtaining unit configured to calculate a similarity between the input sentence and the original sentence, and to obtain the original sentence having the similarity higher than a predetermined threshold value, from the original-sentence storage unit;
a bilingual-term-information obtaining unit configured to obtain the bilingual term information having the identification information corresponding to the original sentence obtained by the original-sentence obtaining unit, from the dictionary storage unit; and
a translating unit configured to determine whether the first word in the bilingual term information obtained by the bilingual-term-information obtaining unit is included in the input sentence, and to translate the first word included in the input sentence into the second word in the bilingual term information, when the first word is included in the input sentence.

2. The apparatus according to claim 1, wherein
the receiving unit receives the translation request including the input sentence and input bilingual term information to be used during translation of the input sentence, and
the translating unit further determines whether the first word in the obtained bilingual term information and the first word in the input bilingual term information are identical, and translates the first word included in the input sentence into the second word in the input bilingual term information, when the first word in the obtained bilingual term information and the first word in the input bilingual term information are identical and the identical first word is included in the input sentence.

3. The apparatus according to claim 1, wherein the original-sentence obtaining unit calculates an edit distance between the input sentence and the original sentence, and assigns a higher similarity to the original sentence having a smaller edit distance than the original sentence having a larger edit distance.

4. The apparatus according to claim 1, wherein
the original-sentence storage unit stores an index including words in the original sentence, the original sentence, and the identification information, which are related to each other, and
the original-sentence obtaining unit obtains the original sentence related to the index including a word in the input sentence from the original-sentence storage unit, and calculates the similarity between the obtained original sentence and the input sentence.

5. The apparatus according to claim 1, wherein the original-sentence obtaining unit obtains a predetermined number of the original sentences in descending order of the similarities from the original-sentence storage unit, among the original sentences having the similarities higher than the threshold value.

6. The apparatus according to claim 1, further comprising:
a converting unit configured to convert the input sentence into a predetermined form capable of comparing similarities to other sentences, wherein
the original-sentence storage unit stores the original sentence converted into the predetermined form and the identification information, which are related to each other, and
the original-sentence obtaining unit calculates the similarities between the converted input sentence and the original sentences, and obtains the original sentence having the similarity higher than the threshold value from the original-sentence storage unit.

7. The apparatus according to claim 6, wherein
the predetermined form is a vector form that is obtained by converting morphemes obtained by a morphological analysis of the input sentence into vectors, and
the original-sentence obtaining unit calculates the similarity as a cosine similarity between the input sentence in the vector form and the original sentence in the vector form, and obtains the original sentence having the cosine similarity higher than the threshold value from the original-sentence storage unit.

8. The apparatus according to claim 1, wherein
the dictionary storage unit stores the bilingual term information, the identification information, and a date and time when the bilingual term information is stored, which are related to each other, and
the bilingual-term-information obtaining unit obtains, among the bilingual term information having the identification information corresponding to the obtained original sentence, the bilingual term information having a more recent date and time related thereto in priority to the bilingual term information having an older date and time related thereto, from the dictionary storage unit.

9. The apparatus according to claim 1, wherein
the dictionary storage unit stores the bilingual term information, the identification information, and a field to which the bilingual term information is applied, which are related to each other,
the receiving unit receives the translation request further including the field, and
the bilingual-term-information obtaining unit obtains, among the bilingual term information having the identification information corresponding to the obtained original sentence, the bilingual term information having the related field that matches the field included in the translation request, in priority to the bilingual term information having the related field that does not match the field included in the translation request, from the dictionary storage unit.

10. The apparatus according to claim 1, wherein
the receiving unit receives the translation request including the input sentence and input bilingual term information that is the bilingual term information to be used for translating the input sentence, and
the apparatus further comprises a storage unit configured to store the input bilingual term information in the dictionary storage unit, and store the identification information of the stored input bilingual term information and the input sentence, which are related to each other.

11. A machine translation method comprising:
receiving a translation request including an input sentence in a first language;
calculating a similarity between the input sentence and original sentence in the first language;
obtaining the original sentence having the similarity higher than a predetermined threshold value, from an original-sentence storage unit configured to store the original sentence and identification information of bilingual term information used for translating the original sentence and relating first words in the first language and second words in a second language to each other;
obtaining the bilingual term information having the identification information corresponding to the obtained original sentence, from a dictionary storage unit configured to store the bilingual term information and the identification information;
determining whether the first word in the obtained bilingual term information is included in the input sentence; and
translating the first word included in the input sentence into the second word in the bilingual term information, when the first word is included in the input sentence.

12. A computer program product having a computer readable medium including programmed instructions for performing machine translation executed by a computer, wherein
the computer includes:
a dictionary storage unit configured to store bilingual term information in which first words in a first language and second words in a second language are related to each other, and identification information that identifies the bilingual term information;
an original-sentence storage unit configured to store original sentence in the first language and the identification information of the bilingual term information used for translating the original sentences, which are related to each other, wherein the instructions, when executed by the computer, cause the computer to perform:
receiving a translation request including an input sentence in the first language;
calculating a similarity between the input sentence and original sentence in the first language;
obtaining the original sentence having the similarity higher than a predetermined threshold value, from the original-sentence storage unit;
obtaining the bilingual term information having the identification information corresponding to the obtained original sentence, from the dictionary storage unit;
determining whether the first word in the obtained bilingual term information is included in the input sentence; and
translating the first word included in the input sentence into the second word in the bilingual term information, when the first word is included in the input sentence.

13. A machine translation system comprising:
a terminal apparatus configured to request a translation; and
a machine translation apparatus configured to be connected to the terminal apparatus via a network, wherein
the terminal apparatus includes:
a request transmitting unit configured to transmit a translation request including an input sentence in a first language; and
a result receiving unit configured to receive a translation result, and
the machine translation apparatus includes:
a dictionary storage unit configured to store bilingual term information in which first words in the first language and second words in a second language are related to each other, and identification information that identifies the bilingual term information;
an original-sentence storage unit configured to store original sentence in the first language and the identification information of the bilingual term information used for translating the original sentence, which are related to each other;
a receiving unit configured to receive the translation request including the input sentence in the first language;
an original-sentence obtaining unit configured to calculate a similarity between the input sentence and the original sentence, and obtain the original sentence having the similarity higher than a predetermined threshold value, from the original-sentence storage unit;
a bilingual-term-information obtaining unit configured to obtain the bilingual term information having the identification information corresponding to the original sentence obtained by the original-sentence obtaining unit, from the dictionary storage unit;
a translating unit configured to determine whether the first word in the bilingual term information obtained by the bilingual-term-information obtaining unit is included in the input sentence, and translate the first word included in the input sentence into the second word in the bilingual term information, when the first word is included in the input sentence; and
an output unit configured to output the translation result translated by the translating unit to the terminal apparatus.
